(19) United States
(12) Patent Application Publication
(10) Pub. No.: US 2010/0283871 A1
(43) Pub. Date: Nov. 11, 2010

(54) Unnecessary Light Identification Method, Unnecessary Light Identification Device, and Imaging Device

(76) Inventor: Hiroshi ISHIDA, Kodaira-shi, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/678,992

(22) PCT Filed: Sep. 10, 2008
(86) PCT No.: PCT/JP2008/066302

§ 371 Date: Mar. 18, 2010

(30) Foreign Application Priority Data
Sep. 21, 2007 (JP) 2007-245112

(51) Int. Cl. H04N 5/217; H04N 5/228

(52) U.S. Cl. 348/241; 348/222.1; 348/E05.031; 348/E05.078

(57) ABSTRACT

It is possible to provide an image capturing device which can identify a ghost image within a captured image, and obtain an image by excluding the identified ghost image. The image capturing device includes: an image capturing optical system which is configured to be rotatable around a nodal point on an image side of a lens; an image capturing element which conducts a photo-electric conversion concerning an image of a subject formed by the image capturing optical system; and an image processing section which conducts predetermined processes on data obtained by the image capturing element. The image processing section determines whether unwanted light is present according to a first image, captured by directing the image capturing optical system to a first direction, and a second image, captured by rotating the image capturing optical system around the nodal point of the image side, thereby creating an image by excluding an unwanted light.

### TECHNICAL FIELD

The present invention relates to an unwanted-light identification method, an unwanted-light identification device, and an imaging device, which can judge the existence of unwanted-light generated by the image capturing optical system etc., in subject images having been captured.

### BACKGROUND ART

In the past, captured image data has been able to be variously processed in the image capturing device employing a solid-state image sensor. After the captured image data is processed to be corrected, said processed and corrected image data has been able to be recorded in a recording media. Employing this advantage, there are some technologies, in which the image quality, which has generally been deteriorated by the unwanted-light generated in the image capturing optical system, can be improved.

As such a device that corrects and records the image data, there is an image capturing device in which after a histogram of luminosity signals obtained by the image sensor is obtained, and after a correction value of a black level is obtained from a previously measured characteristic of the image capturing optical system, said image capturing device records the image data, (for example, refer to Patent Document 1).
Patent Document 1: Unexamined Japanese Patent Application Publication. 2006-165,937

### DISCLOSURE OF THE INVENTION

### Problems to be Solved by the Invention

Concerning the unwanted-light generated by inside reflection within the image capturing optical system, listed are “flare” to reduce the contrast over a majority of an image plane, and “ghost image” to gather reflected light on part of an area of the image plane. Specifically concerning the ghost image, since light is concentrated on parts of the image plane, a captured image existing on the ghost image, is hard to recognize, whereby the image quality is greatly reduced.

The image capturing device, given in above patented documents 1, removes the flare component superimposed on the whole of the captured image, whereby the unwanted-light is not distinguished from an effective image, and if “flare” is effectively controlled, the effective image data is adversely controlled, so that the effective image data is deteriorated. Further, the generation of the ghost image still cannot be overcome. Still further, the only method to determine the ghost image in the captured image is by the human eye, in the conventional art.

In order to overcome the above problems, the object of the present invention is to obtain an unwanted-light identifying method, by which the ghost image is automatically identified in the captured image, and to obtain an unwanted-light identifying device, further, another object of the present invention is to obtain an image capturing device which can eject the ghost image identified by the unwanted-light identifying device, and which can obtain an image including the effective image data being not deteriorated.

### Means to Solve the Problems

The above objects will be attained by the invention detailed below.

Item 1. A method of identifying unwanted-light, using:

an image capturing optical system which is configured to be rotatable around a nodal point on an image side of a lens;

an image capturing element which conducts photo-electric conversion concerning an image of a subject formed by the image capturing optical system; and

an image processing section which conducts predetermined processes on data obtained by the image capturing element,

characterizing the steps of:

obtaining a first image, using the image capturing optical system directed to a first direction;

obtaining a second image using the image capturing optical system being rotated around the nodal point on the image side of the lens of the image capturing optical system, and directed to a second direction; and

identifying existence of unwanted-light, based on the first image and the second image, in the image processing section.

Item 2. An unwanted-light identifying device, which is characterized in that:

an image capturing optical system which is configured to be rotatable around a nodal point on an image side of a lens;

an image capturing element which conducts photo-electric conversion concerning an image of a subject formed by the image capturing optical system; and

an image processing section which conducts predetermined processes on data obtained by the image capturing element,

wherein the image processing section identifies existence of unwanted-light based on:

a first image obtained by the image capturing optical system directed to a first direction; and

a second image obtained by the image capturing optical system rotated around the nodal point on the image side of the lens of the image capturing optical system.

Item 3. An image capturing device, which is characterized in that:

an image capturing optical system which is configured to be rotatable around a nodal point on an image side of a lens;

an image capturing element which conducts photo-electric conversion concerning an image of a subject formed by the image capturing optical system; and

an image processing section which conducts predetermined processes on data obtained by the image capturing element,

wherein the image processing section identifies existence of unwanted-light, and forms an image in which the unwanted-light has been removed, based on:

a first image obtained by the image capturing optical system directed to a first direction; and

a second image obtained by the image capturing optical system rotated around the nodal point on the image side of the lens of the image capturing optical system.

Item 4. The image capturing device, described in Item 3, is characterized in that the image capturing device further includes a display device to display the image in which the unwanted-light has been removed.

Item 5. The image capturing device, described in Item 3 or 4, is characterized in that the image capturing device further includes a recording media to record the image, wherein the image, in which the unwanted-light has been removed by the image processing section, is recorded.

Item 6. The image capturing device, described in Items 3-5, is characterized in that the second image is obtained while the image capturing element is controlled to rotate around an axis on the image capturing element, wherein the axis is parallel to a rotating axis of the image capturing optical system.

That is, the present invention has been attained by the fact that when the image capturing optical system is rotated around the nodal point on the image side of the lens, the image of the subject does not move on an image field, while the ghost image generated by internal reflection moves on the image field.

### Effect of the Invention

Based on the unwanted-light identifying method and the unwanted-light identifying device, of the present invention, any ghost image in the captured image can be automatically identified. Further, based on the image capturing device of the present invention, any identified ghost image can be removed, and the effective image data is not deteriorated, so that a good image can be obtained.

### BRIEF DESCRIPTION OF THE DRAWINGS

FIG. 1 is a perspective view showing the typical appearance of a surveillance camera which is an example of the image capturing device relating to a present embodiment.

FIG. 2 is a block diagram showing typical structure of the surveillance camera which is the example of the image capturing device relating to the present embodiment.

FIG. 3 is a schematic view of the image capturing optical system and an optical system driving section, of the image capturing device relating to the present embodiment.

FIG. 4 are schematic views showing a first image, which is obtained by the image capturing optical system being directed to a first direction, and a second image, which is obtained by the image capturing optical system being rotated around a nodal point on an image side of the lens, and being directed to a second direction.

FIG. 5 is a flow chart showing the operation of the image capturing device relating to the present embodiment.

FIG. 6 is a flow chart showing in detail the operations conducted in the image processing section in Step S107 in FIG. 5.

FIG. 7 are schematic views showing the operation to remove the unwanted-light from the first and second images.

FIG. 8 are schematic views showing examples of the directions of the optical axis, when the first and second images are obtained.

### EXPLANATIONS OF THE NUMERICAL SYMBOLS

1 camera
10 image capturing section
11 image capturing optical system
12 housing
14 image capturing element
15 signal processing section
16 optical system driving section
20 control unit
21 image processing section
22 display section
23 recording media
24 operation section
25 control section
30 cable
31 lens frame
32 holding member
33 lever
35 actuator
40 supporting member

### PREFERRED EMBODIMENT OF THE INVENTION

The present invention will now be detailed, while referring to the embodiment, however the invention is not limited to the embodiment.

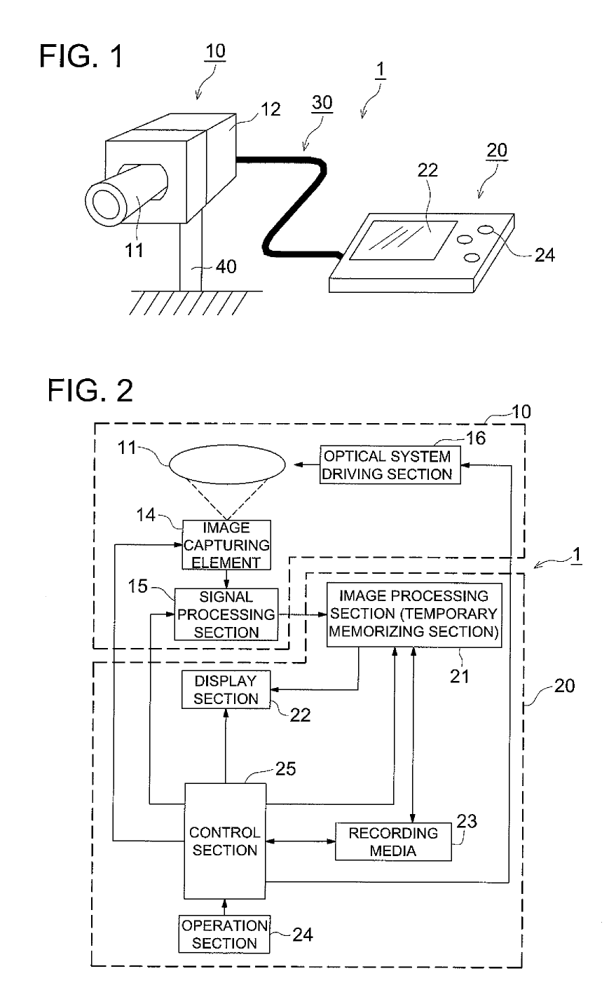

FIG. 1 is a perspective view showing a typical appearance of surveillance camera 1, which is an example of the image capturing device relating to the present embodiment.

As shown in FIG. 1, the appearance of surveillance camera 1, which is an example of the image capturing device relating to the present embodiment, is structured of image capturing section 10 including housing 12 carrying image capturing optical element 11, control unit 20 including display section 22 and operation section 24, cable 30 structured of plural wires, connecting image capturing section 10 with control unit 20 to transmit various signals. Otherwise, the signals can also be transmitted via infrared communication, without using cables.

Image capturing section 10 is supported to be fixed by supporting member 40. An LCD or an organic EL display device is used on display section 22. Various buttons, joystick, and four-way keys are used on operation section 24.

FIG. 2 is a block diagram showing a typical structure of surveillance camera 1 which is the example of the image capturing device relating to the present embodiment. In the following drawings, in order to omit redundant explanations, the same designation numbers are applied to members having the same functions.

Image capturing section 10 of surveillance camera 1 in FIG. 2 includes image capturing optical system 11, image capturing element 14, signal processing section 15, and optical system driving section 16.

Optical system driving section 16 serves as a driving section which is configured to rotate image capturing optical system 11 around the nodal point on the image side of the lens. The driving section can also include a driver to drive a diaphragm, a driver to conduct focusing operation, and a driver to conduct zooming of lens.

Image capturing element 14, serving as an area sensor, includes a CCD (Charge Coupled Device)-type image sensor, or CMOS (Complementary Metal Oxide Semiconductor)-type image sensor. Signal processing section 15 processes output signals from image capturing element 14, and generates an image data to display the captured image.

Control unit 20 includes image processing section 21, display section 22, recording media 23, operation section 24, and control section 25.

Image processing section 21 conducts a predetermined process onto the image data sent from signal processing section 15. Image processing section 22 includes a temporary memorizing section to temporarily memorize the image data sent from signal processing section 15.

Display section 22, to display the image processed by the image processing section 21, is formed of LCD or organic EL display device. Recording media records the image processed by image processing section 21. By operation section 24, instructions to start image capturing, instructions to record the image, and instructions to set various data, are inputted. Control section 25, connected to various sections, controls the total system, based on control programs, and conducts various operating controls.

In the above explanation of the surveillance camera, the image capturing section is separated from the control unit, however, a camera including each section and each unit in a single housing is also possible in the present invention. Further, the border between the image capturing section and the control unit is not limited to the above explanation, yet further a signal receiving section employing a remote control system is possible to use.

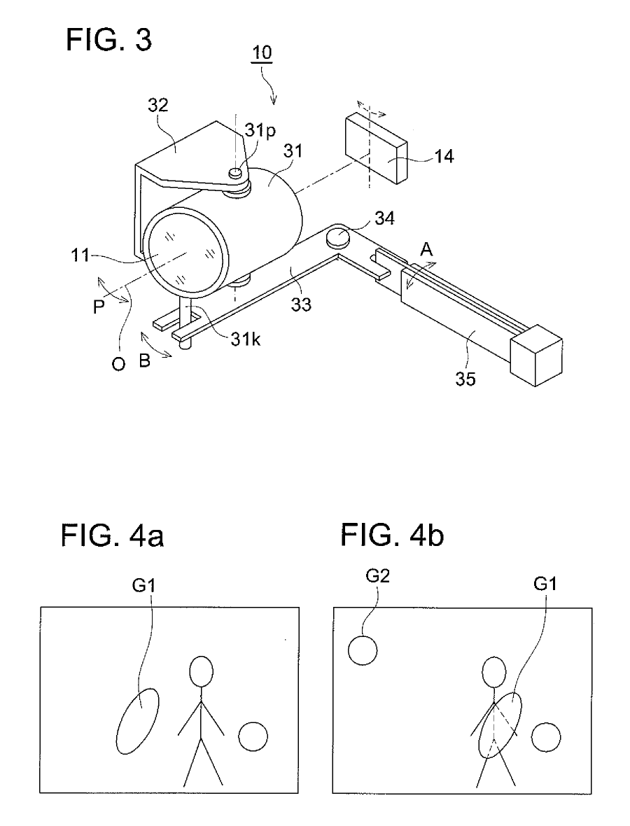

FIG. 3 is a schematic view of image capturing optical system 11 and optical system driving section 16, both arranged in image capturing section 10 relating to the present embodiment.

In FIG. 3, image capturing optical system 11 is supported by lens frame 31. On lens frame 31, two round-bar pins 31P are mounted on positions corresponding to the nodal point on the image side of the lens of image capturing optical system 11. That is, a line, running through the centers of two pins 31P, bisects the optical axis “O” at right angles on the nodal point on the image side of the lens. Lens frame 31 is rotatably supported by U-shaped holding member 32 with two pins 31P at this position. Said holding member 32 is mounted on a fixing member which is not illustrated. Accordingly, image capturing optical system 11 is structured to be rotatable around the nodal point on the image side of the lens.

Further, engaging shaft 31K, which is mounted on lens frame 31, engages an end portion of lever 33, which is pivoted on rotation shaft 34. The top of actuator 35, which is a bimorph type bent by applied voltage, is engaged with the other end of lever 33.

Under the above structure, when the electrical voltage is applied on bimorph type actuator 35, said actuator 35 is bent in arrowed direction “A”, so that lever 33 is rotated in arrowed direction “B”. Simultaneously, engaging shaft 31k is moved, whereby lens frame 31, that is, image capturing optical system 11, is pivoted around the nodal point on the image side of the lens in arrowed direction “P”.

By the way, bimorph type actuator 35 is well known in the art, so that its detailed explanation is omitted. To put it simply, when no electrical voltage is applied on it, it keeps a predetermined shape, while when the electrical voltage is applied on it, its top is moved. In the present embodiment, the image capturing optical system can be structured to rotate in two directions by a non-voltage application and in a one directional voltage application, otherwise it can be structured to rotate in two directions by alternating voltage application. Further, the rotating angle is freely determined so that the image of the subject can be formed within an effective image capturing element area of image capturing element 14, that is, the rotating angle is preferably about 0.5°-20°.

In the above explanation, image capturing optical system 11 is rotated in arrowed direction P around the nodal point on the image side of the lens, otherwise, image capturing element 14 can also be structured to rotate around a line (which is shown by a dashed line) on an image capturing surface of image capturing element 14, which is parallel to the rotation shaft of the image capturing optical system. By this structure, any deterioration of the peripheral image can be controlled, when the rotation angle of image capturing optical system 11 is relatively great, or when an image capturing optical system exhibiting a shallow focal depth is used.

Under the above structure, the image of the subject formed on image capturing optical system 14 is stationary, though image capturing optical system 11 is rotated around the nodal point on the image side of the lens. According to the present invention, it is possible to identify whether the image formed on image capturing optical system 14 is the image of the subject, or the ghost image due to unwanted-light. The identifying method will be detailed below.

FIG. 4 are schematic views showing a first image, which is obtained by image capturing optical system 11, directed to a first direction, and a second image, which is obtained by image capturing optical system 11, rotated around the nodal point on the image side of the lens, and directed to the second direction. FIG. 4a shows the first image, and FIG. 4b shows the second image.

Concerning the first image shown in FIG. 4a, and the second image shown in FIG. 4b, the images of the subject do not move, but the ghost images move. By using this matter, when identical positions of the first and second images are compared to each other, if the signal levels of both images are equivalent, the image is identified as an image of the subject, and if they are not equivalent, the image is identified as a ghost image.

That is, in FIGS. 4a and 4b, when identical positions of the first and second images are compared to each other, area G1 or G2 having a different signal level is identified as the ghost image. This identification is conducted by a way such that plural lines are set on the first and second images by a predetermined pitch in the horizontal or vertical direction, whereby the brightness levels on the identical points of the first and second images are compared to each other. In the above described comparing work, the signal levels should be determined to be equal to each other or not, while studying whether the difference of the signal levels between them is greater than a noise level.

After the above comparing work has been conducted over the whole images, it is possible to identify by the present invention that the data of any position of the obtained image represents the image of the subject, and the data of any position represents the ghost image.

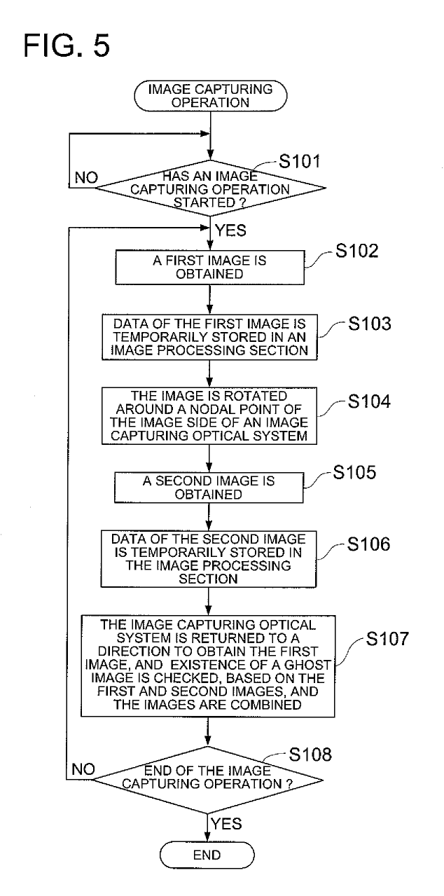

FIG. 5 is a flow chart showing the operation of the image capturing device relating to the present embodiment. The operation flow shown in FIG. 5 concerns an image capturing mode. This operation will now be detailed below, referring to the flow chart.

Firstly, control section 25 waits for an image capturing command (which is step S101). Said command is entered through operation section 24 of control unit 20, or entered through a remote control section.

When the image capturing command has been entered (“Yes” in step S101), the first image is obtained (step S102). The first image is obtained under a condition that bimorph type actuator 35 is not electrically activated, that is, optical axis “O” is set to be orthogonal to the image capturing surface of image capturing element 14. After that, the obtained first image is stored in a temporary memorizing section of image processing section 21 (Step S103).

Subsequently, image capturing optical system 11 is rotated around the nodal point on the image side of the lens (Step S104), which is conducted by electrically activated bimorph type actuator 35. Further, the second image is obtained, under the condition that image capturing optical system 11 is rotated (Step S105). After that the obtained second image is stored in the temporary memorizing section of image processing section 21 (Step S106).

Based on the obtained first and second images, image processing section 21 identifies existence of any ghost image as unwanted-light, and conducts a composite operation. After that, bimorph type actuator 35 is electrically deactivated, so that image capturing optical system 11 is returned to the direction to obtain the first image (Step S107).

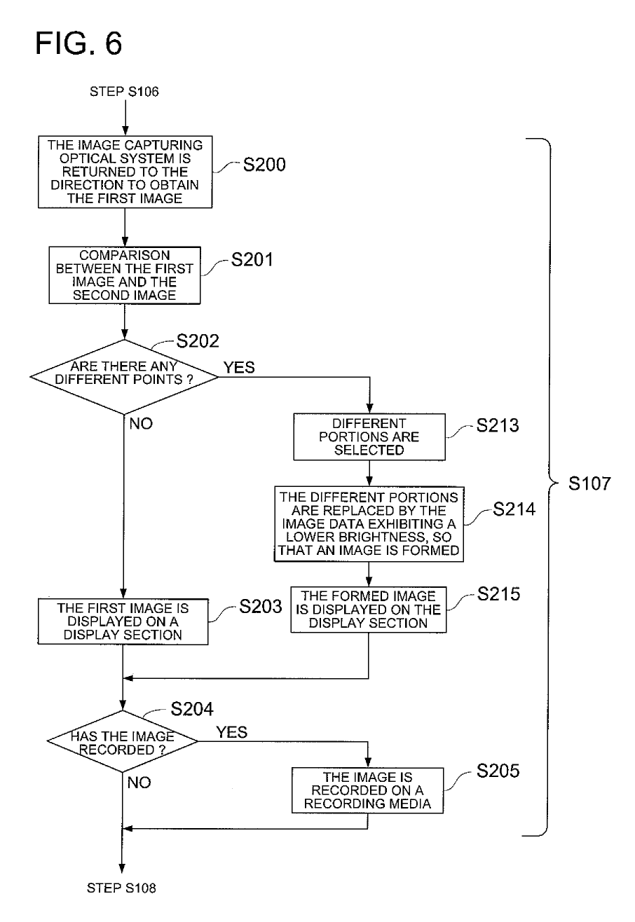

FIG. 6 is a flow chart showing in detail the operation conducted in image processing section 21 in Step S107 in FIG. 5.

In step S106 in FIG. 5, after the data of the second image is memorized, image capturing optical system 11 is returned to the direction to obtain the first image (Step S200). After that, the first image and the second image are compared to each other (Step S201). The method described in FIG. 4 is used for this comparing operation.

Based on the compared result, it is checked that any different points exist or not (Step S202). If the first image is equal to the second image, both having no different point (“No” in step S202), the first image is displayed on display section 22 (Step S203). That is, when the first image has been determined to be equal to the second image, no ghost image has been generated. Instead, the second image can also be displayed.

If the first image is not equal to the second image (“Yes” in Step S202), the different portions are extracted (Step S213). After that, the extracted portion is replaced to the image data exhibiting a lower brightness between the two images, and both images are combined to be a single image (Step S214). Subsequently, the combined image is displayed on display section 22 (Step S215).

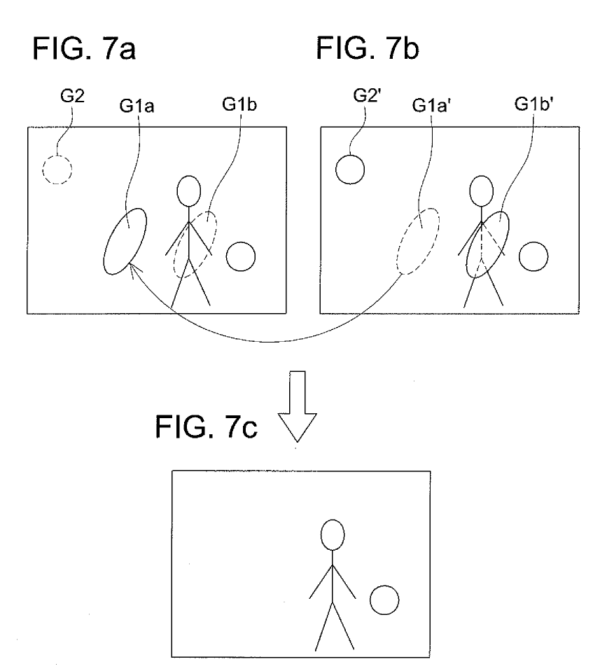

FIG. 7 are schematic views showing the operation to remove the unwanted-light from the first and second images in step S214. FIG. 7a shows the first image, FIG. 7b shows the second image, and FIG. 7c shows a combined image. In this embodiment, the first image represents a base in the explanation.

In FIGS. 7a, 7b and 7c, portions G1a, G1b, and G2, and portions G1a′, G1b′, and G2′, representing the different points, have been extracted in step S213.

With regard to the brightness level, different portion G1a, shown by a solid line in the first image, is compared to portion G1as′, representing a corresponding portion in the second image. If portion G1a′exhibits a lower brightness level, the image data of portion G1a is replaced to the image data of portion G1a′.

With regard to the brightness level, different portion G1b, shown by a dashed line in the first image, is compared to portion G1b′, representing a corresponding portion in the second image. If portion G1b′exhibits a lower brightness level, the image data of portion G1b is not replaced.

With regard to the brightness level, different portion G2, shown by a dashed line in the first image, is compared to portion G2, representing a corresponding portion in the second image. If portion G2 exhibits a lower brightness level, the image data of portion G2 is not replaced.

That is, the portion exhibiting a ghost image in the image is replaced to the image data not exhibiting a ghost image on the corresponding area of the other image.

BY the above procedure, image data from which ghost images have been eliminated as shown in FIG. 7c, can be formed.

Returning to step S203 or step S215 of FIG. 6, the image displayed on the display section is determined by whether it is to be recorded on recording media 23 or not (step S204). To record on recording media 23 or not is previously set.

In the case to record said image (“Yes” in step S204), said image is recorded on recording media 23. In a case not to record said image (“No” in step S204), said image is not recorded, but the operation is shifted to step S108 in FIG. 5.

After that, the control section checks whether the image capturing operation is completed (step S108). If the image capturing operation is to be continued (“No” in step S108), the operation flow returns to step S102, and the operations, described above, are repeated.

If the image capturing operation is to be completed (“Yes” in step S108), said operation is stopped.

The above descriptions are the operation of the image capturing device relating to the present embodiment. In addition, for a moving image capturing operation, the second image is preferably obtained synchronous with obtaining operation of the first image in a frame rate.

In the above described embodiment, the first image is obtained under the condition that the optical axis of image capturing optical system 11 is orthogonal to the image capturing surface of image capturing element 14, while the second image is obtained under the condition that the optical axis is rotated around the nodal point on the image side of the lens. However, the conditions to obtain the first and second images are not limited to the above described conditions.

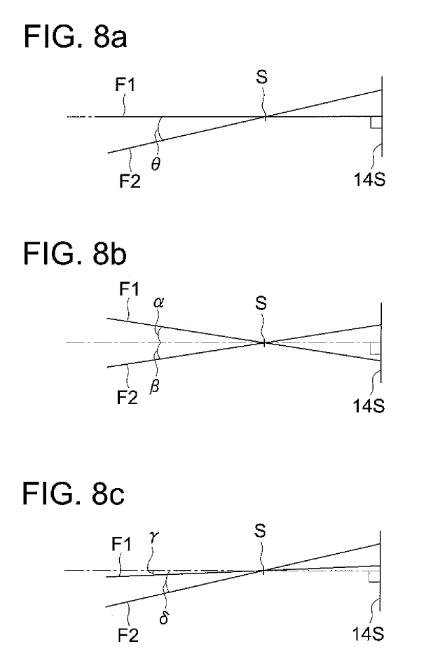

FIG. 8 are schematic views showing examples of the directions of the optical axis, when the first and second images are obtained. Symbol F1 shows the direction of the optical axis to obtain the first image, while symbol F2 shows the direction of the optical axis to obtain the second image. Symbol S represents the nodal point on the image side of the lens of image capturing optical system 11, while symbol 14S represents the image capturing surface of image capturing element 14.

In FIG. 8a, as detailed above, direction F1 of the optical axis to obtain the first image is orthogonal to image capturing surface 14S, while direction F2 of the optical axis to obtain the second image is slanted “θ” on nodal point S on the image side of the lens.

In FIG. 8b, direction F1 of the optical axis to obtain the first image is slanted “α” on nodal point S on the image side of the lens, against a line (which is shown by a chain line) being orthogonal to image capturing surface 14S, while direction F2 of the optical axis to obtain the second image is slanted “β” on nodal point S of the image side of the lens, against the line being orthogonal to image capturing surface 14S, whereby angles “α” and “b” are directed to the opposite directions, against the line being orthogonal to image capturing surface 14S. In this case, angle “α” is equal to angle “β”, or not equal to “β”.

In FIG. 8c, direction F1 of the optical axis to obtain the first image is slanted “γ” on nodal point S of the image side of the lens, against a line (which is shown by a chain line) being orthogonal to image capturing surface 14S, while direction F2 of the optical axis to obtain the second image is slanted “δ” on nodal point S of the image side of the lens, against the line being orthogonal to image capturing surface 14S, whereby angles “γ” and “δ” are directed to the same direction, against the line being orthogonal to image capturing surface 14S. In this case, angle “δ” is not equal to angle “γ”.

Further, to obtain the first and second images, a structure is possible to use, in which the first and the second images are obtained while either the first or second images is rotating.

Still further, in the present embodiment, the bimorph type actuator is used so that the image capturing optical system is rotated around the nodal point on the image side of the lens. However, the invention is not limited to these matters. For example, the image capturing optical system is rotated by a reciprocating movement using a cam.

What is claimed is:

1. A method of identifying an unwanted-light, using:
an image capturing optical system which is configured to be rotatable around a nodal point on an image side of a lens;
an image capturing element which conducts a photo-electric conversion concerning an image of a subject formed by the image capturing optical system; and
an image processing section which conducts predetermined processes on data obtained by the image capturing element,
comprising the steps of:
obtaining a first image using the image capturing optical system directed to a first direction;
obtaining a second image using the image capturing optical system being rotated around the nodal point on the image side of the lens of the image capturing optical system, and directed to a second direction; and
identifying an existence of the unwanted-light, based on the first image and the second image, in the image processing section.

2. An unwanted-light identifying device, comprising:
an image capturing optical system which is configured to be rotatable around a nodal point on an image side of a lens;
an image capturing element which conducts a photo-electric conversion concerning an image of a subject formed by the image capturing optical system; and
an image processing section which conducts predetermined processes on data obtained by the image capturing element,
wherein the image processing section identifies an existence of an unwanted-light based on:
a first image obtained by the image capturing optical system directed to a first direction; and
a second image obtained by the image capturing optical system rotated around the nodal point on the image side of the lens of the image capturing optical system.

3. An image capturing device, comprising:
an image capturing optical system which is configured to be rotatable around a nodal point on an image side of a lens;
an image capturing element which conducts a photo-electric conversion concerning an image of a subject formed by the image capturing optical system; and
an image processing section which conducts predetermined processes on data obtained by the image capturing element,
wherein the image processing section identifies an existence of an unwanted-light, and forms an image in which the unwanted-light has been removed, based on:
a first image obtained by the image capturing optical system directed to a first direction; and
a second image obtained by the image capturing optical system rotated around the nodal point on the image side of the lens of the image capturing optical system.

4. The image capturing device of claim 3, wherein the image capturing device further includes a display device to display the image in which the unwanted-light has been removed.

5. The image capturing device of claim 3, wherein the image capturing device further includes a recording media to record the image, wherein the image, in which the unwanted-light has been removed by the image processing section, is recorded.

6. The image capturing device of claim 3, wherein the second image is obtained, while the image capturing element is controlled to rotate around an axis on the image capturing element, wherein the axis is in parallel to a rotating axis of the image capturing optical system.
